(19) United States
(12) Patent Application Publication
(10) Pub. No.: US 2009/0001720 A1
(43) Pub. Date: Jan. 1, 2009

(54) COUPLING WITH AUTOMATIC SEAL

(76) Inventors: Peter CHEON, Auburn, WA (US); AnKuk SONG, AnYang-Shi (KR); EungSoon LEE, AnYang-Shi (KR); Tim HUNTING, Auburn, WA (US)

Correspondence Address: DWC LAW FIRM, P.S., P.O. BOX 3041, SEATTLE, WA, 98114-3041, US

(21) Appl. No.: 11/772,206

(22) Filed: Jun. 30, 2007

(51) Int. Cl. F16L 39/02

(52) U.S. Cl. 285/317

(57) ABSTRACT

A conduit coupling can have a male portion and a female portion, with each portion having an internal biasing member. The internal biasing members can cause a seal within each of the portions to be biased against an internal wall to seal liquid from leaking out of the portions when they are disconnected. The conduit coupling can also have an absorbing member for absorbing residual fluid when the portions are disconnected.

### BACKGROUND

1. Field of the Invention

The present invention relates to couplings, and more particularly, to couplings having spring loaded sealing capabilities for use in liquid transport conduit systems. 2. Description of Related Art

Conduit systems for transporting fluid, such as, for example, flexible tube systems for transferring liquids, often include stand-alone couplings. There couplings allow users to, among other things, install, maintain or replace discrete and separate conduit sections.

A variety of such couplings are known in the art. For example, U.S. Pat. No. 5,104,158 to Meyer et al., discloses a quick connecting/disconnecting coupling, that includes a female and male coupling member, each having a flow path through which fluid can flow. The coupling has a quick connecting/disconnecting clip member that is slidably mounted on the female coupling member and slidable between a connecting position and a disconnecting position. Although the patent discloses a seal when the male and female coupling members are connected, there is no seal when they are disconnected. As such, pressurized fluid is free to leak from the coupling members when they are disconnected.

In at least one coupling (See, e.g., U.S. Pat. No. 5,104,158) used to connect flexible tubes, automatic sealing is provided upon disconnection of the coupling to prevent discharge of fluids. However, the connection/disconnection mechanism is complicated, a biasing member is unprotected and exposed to external contact, and a release clip may introduce risk of accidental disconnection of the coupling, which could result in leaks. Additionally, residual liquid can leak from a coupling when it is intentionally disconnected. The present invention solves these and other problems associated with the prior art.

### BRIEF SUMMARY OF THE INVENTION

Various embodiments of the present invention provide a conduit coupling for use with fluid conduits that comprise a male portion having a fluid passage and female portion having a fluid passage. The male portion can be connectable to the female portion, and releasably locked together by twisting the portions relative to one another to provide a unified fluid passage through the conduit coupling.

The male portion and female portion can each having an internal biasing member for providing an automatic seal when the portions are disconnected from one another. That is, the internal biasing members can push annular sealing members against a wall within each of the male portion and female portion, to seal the respective portions from discharging fluid when they are disconnected.

The conduit coupling can have one or more non-linear tracks on the female portion for use in releasably and securely locking the female portion to the male portion. Corresponding lock members formed on the male portion, such as stubs, can be insertable into the tracks and movable in a non-linear fashion within the tracks to lock the male portion in a connected position with the female portion.

### BRIEF DESCRIPTION OF THE DRAWINGS

FIG. 1 is a perspective view of an embodiment of a coupling of the present invention.

FIG. 2 is a cross sectional view of the coupling of FIG. 1, showing the male coupling portion and female coupling portion in a connected position.

FIG. 3 is a cross sectional view of the coupling of FIG. 2, showing the male coupling portion and female coupling portion in a disconnected position.

FIG. 4 is a perspective exploded view showing components of the female coupling portion of FIG. 1.

FIG. 5 is a perspective exploded view showing components of the male coupling portion of FIG. 1.

FIG. 6 is a side elevation view of the coupling of FIG. 1.

FIG. 7 is simplified side elevation view of the flange portion of the female coupling portion of FIG. 6, showing an interaction between a stub and a track of a releasable lock for the present invention.

### DETAILED DESCRIPTION OF PREFERRED EMBODIMENTS

In the following description, certain specific details are set forth in order to provide a thorough understanding of various embodiments of the invention. However, upon reviewing this disclosure, one skilled in the art will understand that the invention may be practiced without many of these details. In other instances, well-known structures related to tubes, conduits, springs and materials of construction have not been described in detail to avoid unnecessarily obscuring the descriptions of the embodiments of the invention.

Various embodiments of the present invention are described and illustrated in the context of use for connecting flexible tubes. However, as those skilled in the art will appreciate after reviewing this disclosure, various other types of conduits are contemplated for use with the present invention. The connections between the conduit sections and coupling of the present invention can be modified for connection to different types of conduits.

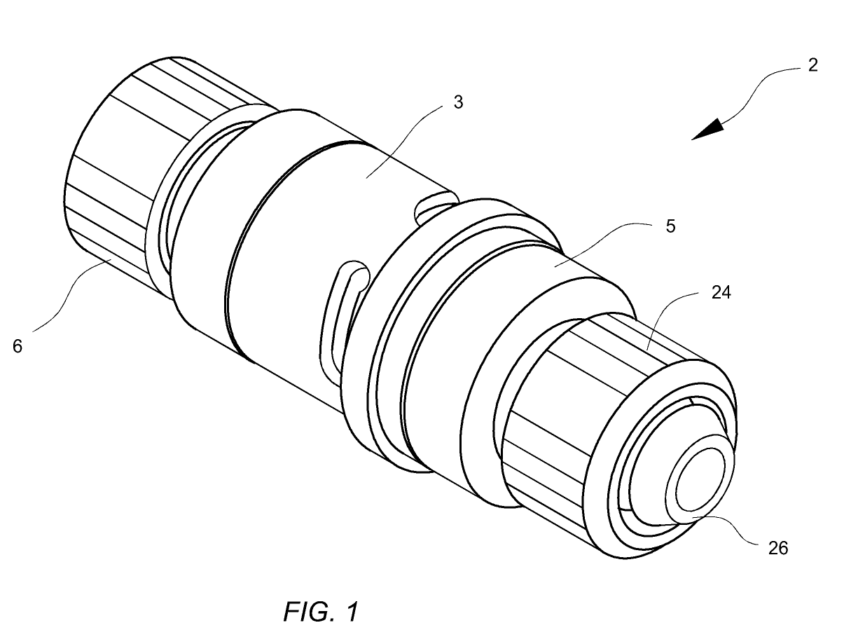

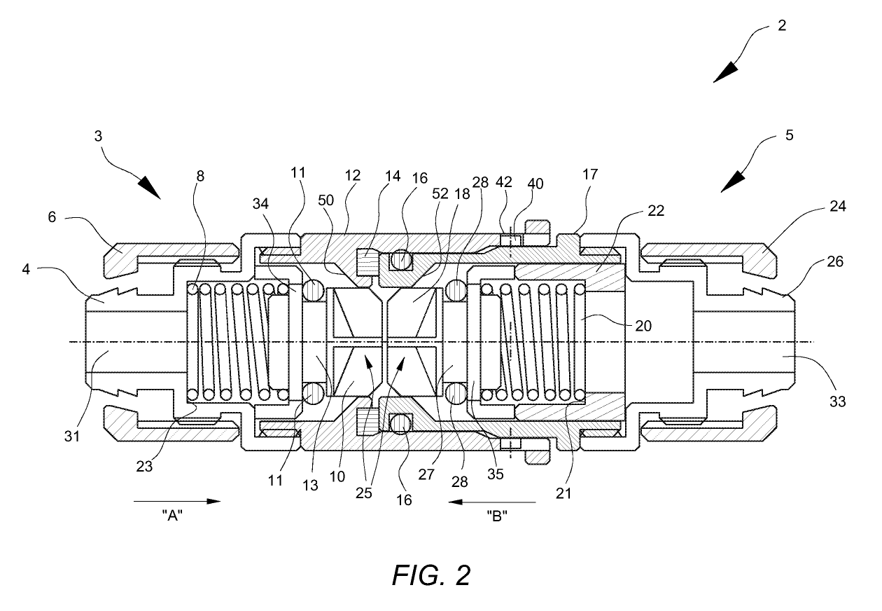

FIG. 1 shows an embodiment of the coupling 2 of the present invention, having a female portion 3 and a male portion 5, with end caps 6, 24 and tube connector 26 on the male portion (tube connector 4 visible on the female portion in FIG. 2).

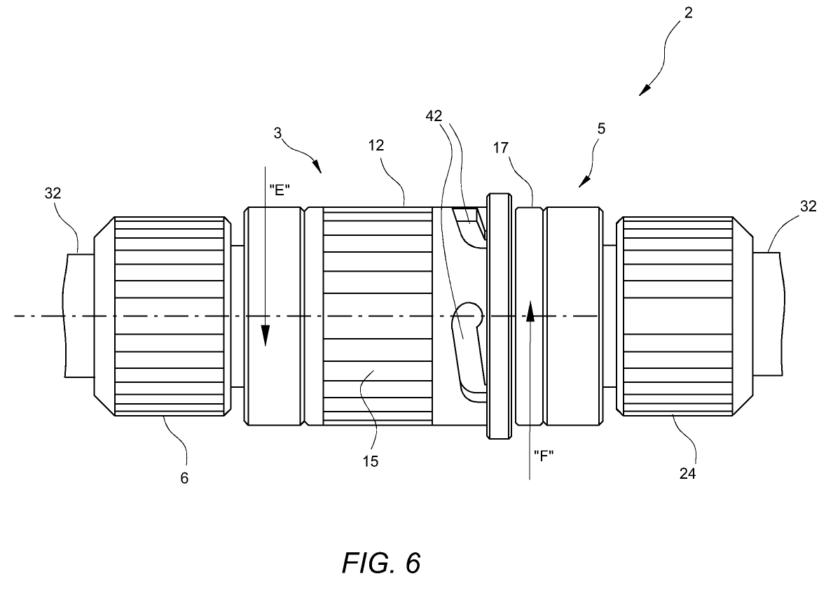

Referring to FIG. 6, conduit sections 32, such as flexible tube sections, can be sealably connected to the conduit coupling 2 and locked in place using end caps 6, 24.

Now referring to FIGS. 2 & 3, each of the coupling portions, female portion 3 and male portion 5, has an interior fluid channel that can pass over channel members (or valves) 10, 18 within the fluid channel, to allow fluid to flow through the coupling 2. Each of the coupling portions 3, 5 also has a biasing member 8, 20, which can be a coil spring in some embodiments of the present invention. The biasing members 8, 20 are set adjacent interior retaining walls 23, 21 of the respective female portion 3 and male portions 5, as can be seen in FIG. 2.

The biasing members 8, 20 provide biasing force against the channel members 10, 18 in the directions of arrows “A” and “B” respectively, and against annular seals 11, 28, which can be O-ring seals that circumferentially surround neck portions 13, 27 of the channel members 10, 18. As can be seen from FIGS. 2 & 4 in combination, the neck portions 13, 27 of the channel members 10, 18 can be circular.

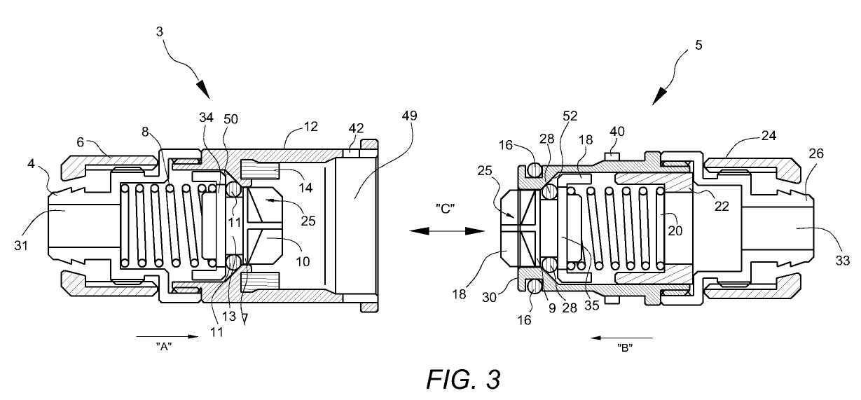

As best seen in FIG. 3, showing the coupling 2 in a disconnected position, when the annular seals 11, 28 are freely biased in the direction of arrows “A” and “B” respectively, the annular seals 11, 28 are compressed against sealing walls 50, 52 of the female portion 3 and male portion 5, respectively. However, when an inward section 30 of the male portion 5 is manually inserted into a receiving chamber 49 of the female portion 3 in the direction of arrow “C,” end portions of the channel members 10, 18 abut and apply force against the biasing members 8, 20 to cause each of the channel members 10, 18 to recede in an opposite direction from the approaching channel member. This, in turn, causes the annular seals 11, 28 to recede away from the sealing walls 50, 52 until they come to rest in their respective positions shown in FIG. 2. FIG. 2 is reflective of the connected position for the coupling 2.

As will be appreciated by one skilled in the art after reviewing this disclosure, the disconnected position shown in FIG. 3, provides an automatic seal via the compression of the annular seals 11, 28 against the sealing walls 50, 52. Fluid in the female portion 3 and male portion 5 of the coupling 2, which has entered into the coupling portions via fluid passage 31 or 33 (one of which is an entrance to the coupling 2, and one of which is an exit from the coupling 2, depending on direction of flow), is sealed from being discharged. As such, a sudden release of liquid from the coupling due to pressure drop from disconnecting the coupling and exposing it to atmospheric pressure, can be substantially prevented.

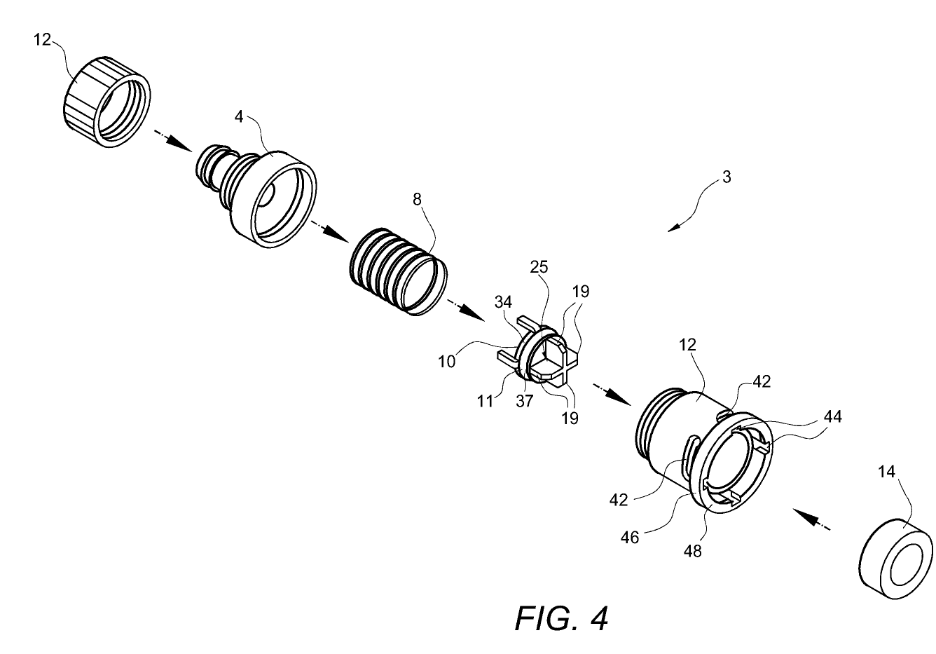

A releasable lock assembly is provided between the female portion 3 and male portion 5. First, referring to FIG. 4, the female portion 3 is provided with tracks 42 that extend through a wall of the female portion 3, near a flange 46. The tracks 42 also extend beneath a section of the flange 46, as best seen in FIG. 4. As such, track entrances 44 can be seen on the face 48 of the flange 46.

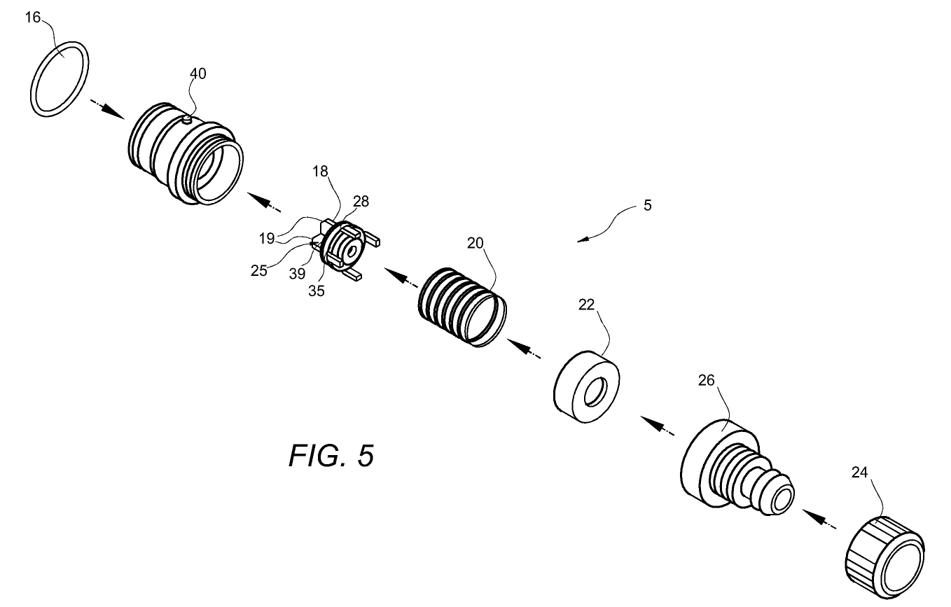

The tracks 42 are configured to receive stub members 40 of the male portion 5. A stub member 40 can be seen in FIG. 5. Multiple stub members 40 can be provided on the male portion 5 and multiple corresponding tracks 42 can be provided on the female portion 3, as will be appreciated by those skilled in the art after reviewing this disclosure.

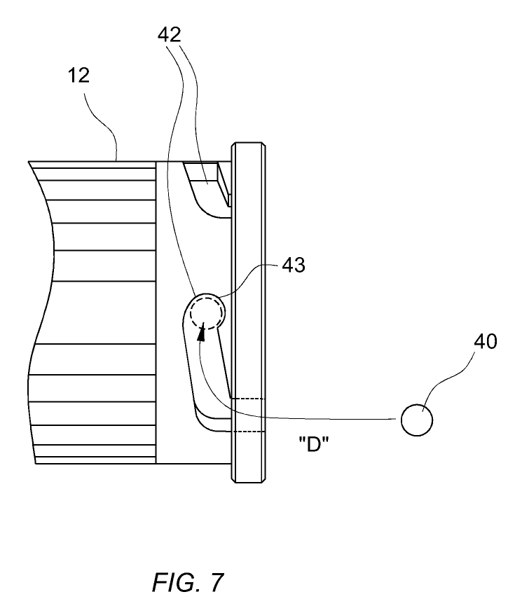

When an inward section of the male portion 5 is inserted into the receiving chamber 49 of the female portion 3, one or more stub members 40 on the male portion 5 can be aligned with one or more corresponding track entrances 44, such that the stub members 40 can be pushed into the track 42, in the direction of arrow “D,” as shown in FIG. 7. Arrow “D” moves forward into the track 42, then circumferentially across with respect to the surface of the female portion 3, then slightly back into a resting gap 43, to securely hold and releasably lock the male portion 5 in a connected position with the female portion 3. This can be accomplished by manually pushing the coupling portions 3, 5 together, then twisting them with respect to one another in the directions represented by arrows “E” and “F” shown in FIG. 6. The coupling portions can be unlocked from one another by moving them in the opposite direction of arrow “D,” to disconnect the female portion 3 and male portion 5 from one another. In some embodiments of the present invention, an outer grip member 15 is provided, which can be a grill-like surface to allow a user to grip the coupling 2 to turn it during locking and releasing.

When the female portion 3 and male portion 5 are in the connected position, as shown in FIG. 2, the annular seals 11, 28 are receded from the sealing walls 50, 52 respectively. Also, the channel members 10, 18 are receded inward into the respective female and male portions. As such, fluid can flow past the annular seals 11, 18 and past wedge gaps 25 of the channel members 10, 18. The wedge gaps 25 are formed between fins 19 (shown in FIGS. 4, 5) of the channel members 10, 28 and provide sufficiently large gaps for fluid to flow through to reduce pressure drop across the coupling 2. The fins 19 of each channel member 10, 18 can be planar walls aligned in parallel with a longitudinal axis of the conduit coupling 2, and can be connected to a circular wall 37, 39 of each channel member. When the conduit portions 3, 5 are disconnected, the channel members 10, 18 can be positioned such that their respective circular walls 37, 39 are substantially and snugly aligned with an opening of the respective sealing walls 50, 52. When the conduit portions 3, 5 are connected, the respective wedge gaps 25 of the channel members are aligned with the openings of the respective sealing walls 50, 52 to allow fluid to flow through the wedge gaps.

Furthermore, as can be seen in FIG. 2, when the coupling portions 3, 5 are connected, a sponge ring 14 of the female portion 3 is compressed against an inwardly facing wall of the male portion 5, and an annular connection seal 16 of the male portion 5 is compressed against an inside wall of the receiving chamber 49 of the female portion. As will be appreciated by those skilled in the art, the annular connection seal can prevent higher-pressure fluid inside the coupling 2 from leaking out of the coupling during use when the coupling is in a connected position. Also, the sponge ring 14 (also shown in FIGS. 3 & 4) can have absorbent characteristics, and can thus help absorb residual fluid in, for example, the receiving chamber 49 when the female portion 3 and male portion 5 are disconnected, thus further preventing fluid from spilling when the female and male portions are disconnected. The decompression of the sponge ring 14 when the female portion 3 is disconnected from the male portion 5 can allow the sponge ring to expand and absorb liquid.

Although specific embodiments and examples of the invention have been described supra for illustrative purposes, various equivalent modifications can be made without departing from the spirit and scope of the invention, as will be recognized by those skilled in the relevant art after reviewing the present disclosure. The various embodiments described can be combined to provide further embodiments. The described apparatus and methods can omit some elements or acts, can add other elements or acts, or can combine the elements or execute the acts in a different manner or order than that illustrated, to achieve various advantages of the invention. These and other changes can be made to the invention in light of the above detailed description.

In general, in the following claims, the terms used should not be construed to limit the invention to the specific embodiments disclosed in the specification. Accordingly, the invention is not limited by the disclosure, but instead its scope is determined entirely by the following claims.

What is claimed is:

1. A conduit coupling for a fluid comprising:
a male portion having a fluid passage;
a female portion having a fluid passage;
the male portion being connectable to the female portion to releasably and securely lock the portions together in a sealed position;
at least one of the male portion and female portion having an internal biasing member for providing an automatic seal when the portions are disconnected from one another; and
an absorbing member, disposed proximate mating walls of the female portion and male portion, to absorb residual fluid when the portions are disconnected.

2. The conduit coupling of claim 1 wherein at least one of the internal biasing members pushes an annular sealing member against a wall when the male portion is disconnected from the female portion, and wherein when the male portion and female portion are connected, a channel member in each of the portions contacts a channel member in the other portion, which applies force against the internal biasing member to recede the annular sealing member away from the wall.

3. The conduit coupling of claim 2 wherein the channel members also have a plurality of fluid passages separated by fin portions of the channel members, and wherein the fin portions are the portions of the channel members that contact one another when force is applied against the internal biasing member.

4. The conduit coupling of claim 1 wherein the absorbing member can be expanded when the female portion and male portion are disconnected.

5. The conduit coupling of claim 1 further comprising a non-linear track on the female portion for use in releasably and securely locking the female portion to the male portion.

6. The conduit coupling of claim 5 further comprising a corresponding lock member formed on the male portion that is insertable into the track and movable in a non-linear fashion within the track to lock the male portion in a connected position with the female portion.

7. The conduit coupling of claim 1 further comprising a gripping member formed on a surface of the conduit coupling for providing friction used to grip the conduit coupling to twist it in order to releaseably lock the male portion and female portion together.

8. A conduit coupling comprising:
a first portion having a fluid passage;
a second portion having a fluid passage, the second portion being connectable to the first portion in a releasably locked position to form a fluid passage through both portions;
a first channel member disposed within the first portion;
a second channel member disposed within the second portion, wherein when the first portion and second portion are connected, the respective channel members abut and depress one another to cause at least one biasing member in at least one of the first portion and second portion to compress;
a sealing member, wherein when the at least one biasing member is compressed, the sealing member is displaced from a wall to allow fluid to flow through at least one of the fluid passages, and when the biasing member is decompressed, the sealing member interacts with the wall to block the at least one of the fluid passages; and
at least one absorbing member coupled to at least one of the first portion and second portion, the absorbing member being compressed when the first and second portions are connected, and expanded when the first and second portions are disconnected.

9. The conduit coupling of claim 8 wherein the channel members each have protruding walls that are generally planar and parallel to a longitudinal axis of the conduit coupling, and wherein edges of the protruding walls abut when the first portion and second portion are connected.

10. The conduit coupling of claim 8 wherein the first portion has a track for use in releasably locking the first portion and second portion together.

11. The conduit coupling of claim 10 wherein the second portion has a stub insertable into the track, and movable within the track in a non-linear fashion.

12. The conduit coupling of claim 8 wherein each of the first and second channel members comprises a retaining section for retaining an annular seal.

13. The conduit coupling of claim 8 wherein each of the first and second channel members comprises wedge gaps for accommodating fluid flow.

14. A method of connecting and disconnecting conduit sections using a conduit coupling comprising:
inserting a male portion of the conduit coupling into a female portion of the conduit coupling;
compressing a biasing member disposed within the female portion and compressing a biasing member disposed within the male portion;
displacing a sealing member within each of the female portion and male portion to open a fluid passage in each of the portions;
compressing an absorbing member coupled to at least one of the male portion and female portion near an opening of at least one of the portions;
releasably locking the male portion to the female portion;
disconnecting the male portion from the female portion;
decompressing the biasing members; and
expanding the absorbing member.

15. The method of claim 14 wherein decompressing the biasing member comprises displacing the sealing members to close the fluid passage within each of the female portion and male portion.

16. The method of claim 14 wherein compressing the biasing member comprises abutting an end portion of a channel member in the female portion against an end portion of a channel member in the male portion.

17. The method of claim 16 wherein the end portions of the channel members are disposed on planar wall members oriented in parallel relation with respect to a longitudinal axis of the conduit coupling.

18. The method of claim 16 wherein each of the channel members comprises a plurality of planar wall members oriented in parallel relation with respect to a longitudinal axis of the conduit coupling.

19. The method of claim 14 wherein at least one of the female portion or male portion has a surface gripping member for use in manually gripping and twisting the portions relative to one another in order to releasably lock the portions together.

20. The method of claim 14 wherein each of the male portion and female portion comprises a channel member that is in contact with a biasing member, with the channel members being in contact with one another when the male portion and female portion are connected, and with each channel member also having an annular seal coupled thereto.
